(19) United States
(12) Patent Application Publication
(10) Pub. No.: US 2023/0170761 A1
(43) Pub. Date: Jun. 1, 2023

(54) INTEGRATED FLYWHEEL CONTROL APPARATUS FOR APPLYING RESISTING FORCE OR DRIVING FORCE TO FLYWHEEL

(71) Applicant: YU-YU CHEN, TAIPEI CITY (TW)

(72) Inventor: YU-YU CHEN, TAIPEI CITY (TW)

(21) Appl. No.: 18/058,780

(22) Filed: Nov. 25, 2022

(30) Foreign Application Priority Data
Nov. 29, 2021 (TW) 110214174

(51) Int. Cl. H02K 7/02

(52) U.S. Cl. CPC H02K 7/025

(57) ABSTRACT

An integrated flywheel control apparatus for applying resisting force or driving force to a flywheel includes a resistance applying device mounted to an outer frame of a stator holder frame and arranged in a receiving space of a flywheel. A power generation/drive device is positioned on an inner frame of the stator holder frame. When the flywheel is acted upon by an external force to rotate, the power generation/drive device is caused by the rotation of the flywheel to rotate and a plurality of power actuating windings of the power generation/drive device generate electrical energy. The electrical energy is supplied to resistance applying device to apply a resisting force to the flywheel. When the power actuating windings of the power generation/drive device is supplied with an external electrical power, the power actuating windings are electromagnetically coupled to a plurality of magnets circumferentially arranged on an axle portion of the wheel to drive the flywheel to rotate.

### BACKGROUND OF THE INVENTION

### 1. Field of the Invention

The present invention relates to a device for controlling a flywheel, and more particularly to an integrated flywheel control apparatus for applying resisting force or driving force to the flywheel.

### 2. The Related Arts

A known exercise bike is structured to allow a user to drive a flywheel by treading pedals, in order to achieve the purposes of exercise and body fitting. To achieve diversification of exercise doing for a user, products that additionally include a resistance system are available. To generate a desired force of resistance or impedance, a commonly adopted solution is a magnetism-controlled resistance device, which enables adjustment of the magnitude of the resisting force generated for the exercise bike, in order to allow the user to experience various effects of exercise by means of different resistances or impedances.

Further, in addition to the magnetism-controlled resistance device, the known exercise bike may also be equipped with an arrangement for generating electrical power, of which the purpose is that when a user is exercising by pedaling the bike, the force applied through the pedals drives the magnetism-controlled resistance device to rotate so as to generate electrical power. Such electrical power can be applied to an external electromagnetic device to induce magnetic attraction to the flywheel that is rotating to form a resistance applying device.

In another known design of exercise bike, a device that directly receives an external power supply to activate such a magnetism-controlled resistance device that induces electromagnetic attraction to a rotating flywheel to achieve an effect of resistance-based braking. In such an arrangement, generally, no electrical power generation device is included, and it is not possible to operate in an electric machine driving mode.

In the known arrangements, which include an electric machine driving device in an exercise bike, in view of the concern about the electric machine driving efficiency, theoretically, the electric machine driving device is contradictory to the resistance braking operation, making it impossible to combine or integrate them together as a single unit, so that the overall structure is complicated, and it comes that only an externally connected resistor may help consume the electrical power generated by the rotation of the flywheel in the form of thermal energy that is dissipated to the surrounding, or an additional fan may be included for dissipating such thermal energy. This makes it not possible to meet the requirement for environmental conservation stipulated in all the countries around the world, and also not good for application to virtual reality (VR) and augmented reality (AR).

Primary shortcomings of the flywheel resistance driving systems of the known exercise bikes are as follows:

(1) In the known exercise bike flywheel resistance driving system, the main structure is divided into two major portions, which are respectively power generation and resistance braking. The power generation portion is arranged on a stator device in an interior of the flywheel, while the resistance braking portion is arranged as a separate fixed device outside the flywheel, forming a separate arrangement, making assembling extremely sophisticated and maintenance difficult, and material cost increased.

(2) The known exercise bike flywheel resistance driving system has a complicated structure, which is not of an integrated or embedded arrangement, so that a fixing frame must be additionally arranged for holding and supporting an electromagnetic device, this making the structure further complicated and not easy to control quality.

(3) The known exercise bike flywheel resistance driving system, of which the main structure includes the two major portions of power generation and resistance braking, does not provide a function of electrical driving, and is not operable in an electrical driving mode, and thus cannot serve as an electric machine driving system in a downslope scenario in virtual reality applications.

(4) The known exercise bike flywheel resistance driving system needs an external electrical power supply to form an electric machine driving device, and also needs an external resistor for consuming the electrical energy and also needs a heat dissipation device, making the structure complicated, the cost extremely high, and the resistance braking performance poor. Further, such an arrangement does not provide a self-power generation function, and is not environmentally friendly. Further, such a known arrangement generates a great amount of thermal energy, resulting in incompliance to the trend for environmental conservation, having poor quality and high cost, and being easy to generate noise.

### SUMMARY OF THE INVENTION

In view of the primary shortcomings of a known exercise bike and for breakthrough of theoretic constraint, the primary objective of the present invention is to provide a resistance generating and driving device for a flywheel, which provides an integrated or embedded apparatus for applying resisting force or driving force to the flywheel that has a high efficiency, high quality, and low cost, and is completely compliant with the requirement for environmental protection.

A technical solution adopted in the present invention includes a resistance applying device mounted to an outer frame of a stator holder frame and arranged in a receiving space of a flywheel. A power generation/drive device is positioned on an inner frame of the stator holder frame. When the flywheel is acted upon by an external force to rotate, the power generation/drive device is caused by the rotation of the flywheel to rotate and a plurality of power actuating windings of the power generation/drive device generate an electrical energy. The electrical energy is supplied to resistance applying device to apply a resisting force to the flywheel. When the plurality of power actuating windings of the power generation/drive device is supplied with an external electrical power, the power actuating windings are electromagnetically coupled to a plurality of magnets circumferentially arranged on an axle portion of the wheel to drive the flywheel to rotate.

In respect of the efficacy, in addition to generation of electrical energy through conversion from kinetic energy of a flywheel induced by a force applied by a treading motion of a user, the present invention also allows electrical energy to be fed to a resistance applying device in an internal stator thereof to generate resistance braking on the flywheel that is in rotation.

In addition to generation of electrical energy through conversion from kinetic energy of a flywheel induced by a force applied by a treading motion of a user, the present invention also allows for accumulation and storage of the electrical energy generated by the motion of the rider for application to form an electric machine automatic driving device in a downslope scenario of virtual reality.

The present invention possesses functions of electric machine, resistance braking, and electric machine driving device, and is applicable, in addition to serving as an exercise bike, to an outdoor bicycle, so hat when a rider applies a force, through treading, to a rotor flywheel of which a kinetic energy is converted into electrical energy by means of self power generation, and allows such electrical energy to be applied to an electromagnetic device to induce resistance braking on the flywheel in rotation.

Further, when the rider applies a force, through treading, to the rotate flywheel in a condition of simulating an uphill scenario, the internal generator windings and magnets inside of the rotor flywheel move relative to each other to convert kinetic energy into electrical energy of self power generation. In addition to being supplied as electrical energy to the resistance applying device of the stator to generate an electromagnetic field to induce a resisting effect through relative movement with respect to the flywheel, the electrical energy can also be fed to and charged into the energy storage device. In simulation of a downhill scenario or in case that the rider requires assistance, the present invention can be switched to operation of an electric machine driving mode.

A technical solution adopted in the present invention will be further described with reference to embodiments provided below and the attached drawings.

### BRIEF DESCRIPTION OF THE DRAWINGS

FIG. 1 is a perspective view of a first embodiment of the present invention;

FIG. 2 is a front view of the first embodiment of the present invention;

FIG. 3 is a side elevational view of the first embodiment of the present invention;

FIG. 4 is a cross-sectional view taken along line A-A of FIG. 2;

FIG. 5 is a perspective view showing components of the first embodiment of the present invention in a separated condition;

FIG. 6 is a block diagram of a control circuit of the present invention;

FIG. 7 is a perspective view of a second embodiment of the present invention;

FIG. 8 is a front view of the second embodiment of the present invention;

FIG. 9 is a side elevational view of the first embodiment of the present invention;

FIG. 10 is a cross-sectional view taken along line B-B of FIG. 8;

FIG. 11 is an exploded view showing components of the second embodiment of the present invention in a separated condition; and

FIG. 12 is a schematic view showing an application of the present invention in simulating a strength training machine.

### DETAILED DESCRIPTION OF THE PREFERRED EMBODIMENTS

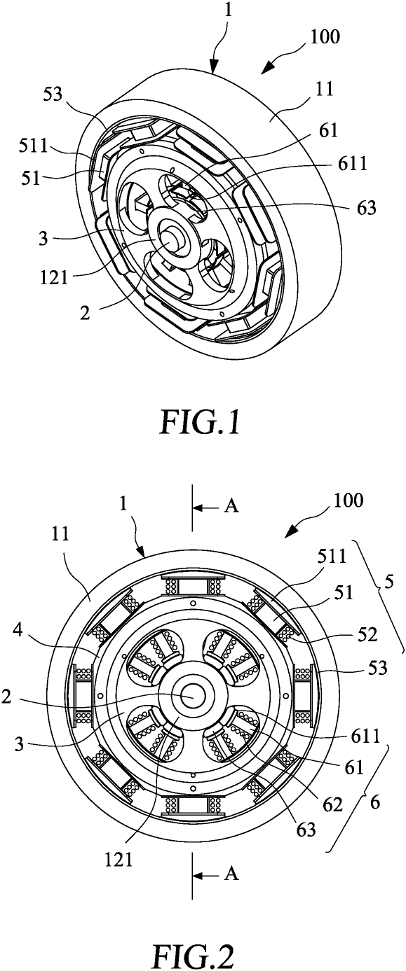

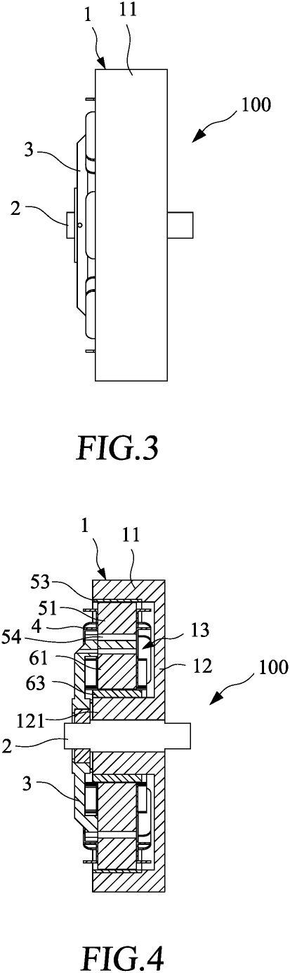

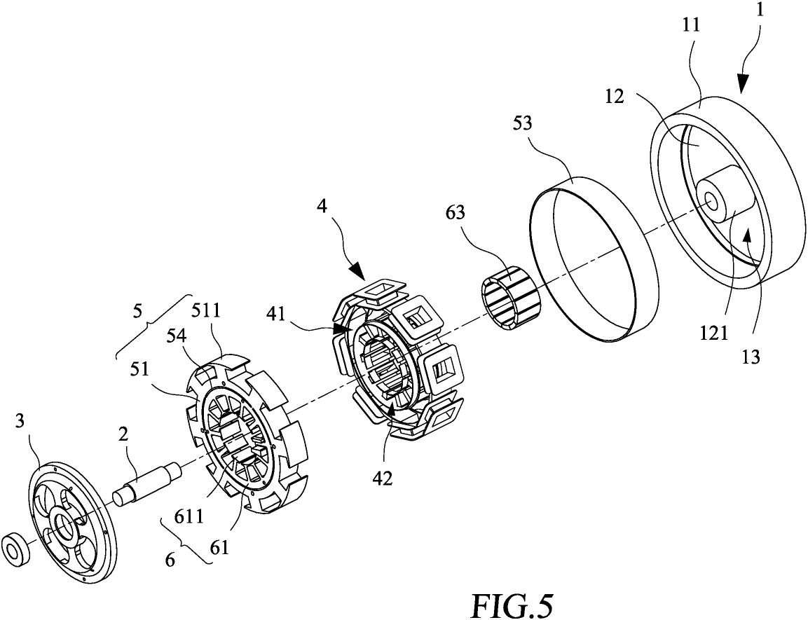

Referring to FIGS. 1-5, which show, respectively, a perspective view, a front view, a side elevational view, a cross-sectional view taken along line A-A of FIG. 2, and an exploded view of an integrated flywheel control apparatus 100 embedded in a flywheel 1 according to a first embodiment of the present invention. The flywheel 1 comprises a wheel body 11 and a sidewall 12 that jointly define a receiving space 13. The wheel body 11 has a side that is opposite to the sidewall 12 of the flywheel 1 and is formed as an open side.

The sidewall 12 of the flywheel 1 is combined with an axle portion 121, and is rotatably mounted, by means of a known bearing, to a central shaft 2. The central shaft 2 is provided, on an end thereof that is opposite to the sidewall 12, with a mounting seat 3 mounted thereto. The flywheel 1 is mechanically coupled (by means of a belt or a chain, or the likes) to a chain wheel (not shown) of an exercise bike or an exercise equipment, so that a user may apply a force to pedals of the exercise bike to drive the flywheel 1 to rotate.

A stator holder frame 4 is arranged in and mounted in the receiving space 13 of the flywheel 1. In other words, the stator holder frame 4 is located between the mounting seat 3 and the sidewall 12 of the flywheel 1. The stator holder frame 4 defines an outer frame 41 and an inner frame 42.

A resistance applying device 5 comprises a first silicon lamination member 51, a plurality of resistance actuating windings 52, and a high magnetic permeability ring 53. To simplify the drawings and to more clearly illustrate a relationship among various components, the resistance actuating windings 52 are not shown in the drawings, and the resistance actuating windings 52 are only illustrated in FIG. 2. In case that the flywheel 1 is made of magnetic permeability material, there is no need to include the high magnetic permeability ring 53.

The first silicon lamination member 51 is made of a low-carbon steel material (such as a silicon steel component). The first silicon lamination member 51 has an outer annular surface from which a plurality of circumferentially arranged magnetic poles 511 are protruded outward, and the resistance actuating windings 52 are wound around each of the magnetic poles 511. The first silicon lamination member 51 has an inner annular surface that forms a central hollow space 54.

The high magnetic permeability ring 53 is circumferentially arranged on an inner annular surface of the wheel body 11 of the flywheel 1 and is rotatable in unison with the flywheel 1. The high magnetic permeability ring 53 is made of a metal material with high magnetic permeability.

After each of the magnetic poles 511 is wound with the resistance actuating windings 52, the first silicon lamination member 51 is fit to and positioned on the outer frame 41 of the stator holder frame 4, in such a manner that an external end face of each of the magnetic poles 511 is facing an inner annular surface of the high magnetic permeability ring 53 with a gap formed therebetween.

A power generation/drive device 6 comprises a second silicon lamination member 61, a plurality of power actuating windings 62, and a plurality of magnets 63 that are arranged circumferentially and spaced from each other. To simplify the drawings and to more clearly illustrate a relationship among various components, the power actuating windings 62 are not shown in the drawings, and the power actuating windings 62 are only illustrated in FIG. 2.

The second silicon lamination member 61 has an outer annular surface that corresponds to and is fit in the central hollow space 54 of the first silicon lamination member 51 of the resistance applying device 5. Thus, a side surface of the second silicon lamination member 61 is substantially coplanar with a side surface of the first silicon lamination member 51.

The second silicon lamination member 61 has an inner annular surface from which a plurality of circumferentially arranged magnetic poles 611 are protruded inward, and the power actuating windings 62 are wound around each of the magnetic poles 611. The power actuating windings 62 may be for example windings of three phases or more than three phases.

Each of the magnets 63 is circumferentially arranged an outer annular surface of the axle portion 121 of the flywheel 1 and is facing the circumferentially arranged magnetic poles 611 of the second silicon lamination member 61, with a gap formed therebetween.

The second silicon lamination member 61, after being wound with the power actuating windings 62, is fit to and positioned on the inner frame 42 of the stator holder frame 4, in such a manner that each of the magnetic poles 611 is facing an outer annular surface of the magnets 63, with a gap formed therebetween.

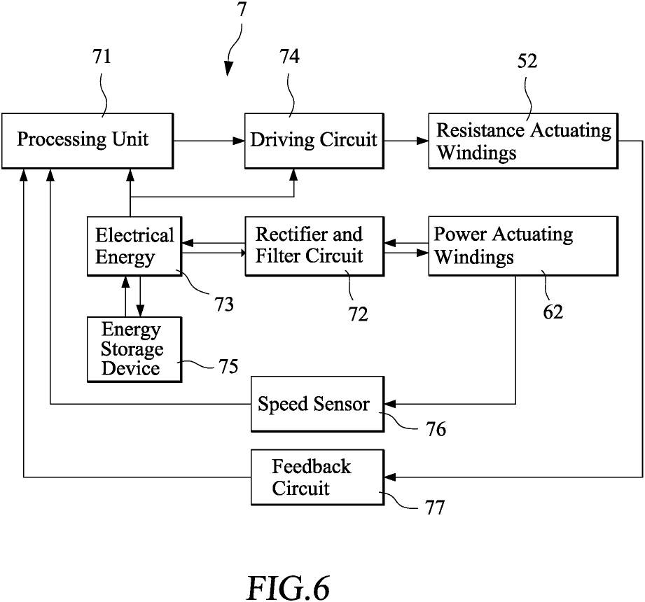

FIG. 6 shows a diagram of a control circuit of the present invention. The control circuit 7 of the present invention comprises a processing unit 71; and a rectifier and filter circuit 72 that is connected to the power actuating windings 62 of the power generation/drive device 6 to rectify and filter electrical energy generated by the power actuating windings 62 to generate electrical energy 73. A driving circuit 74 is connected to the processing unit 71 and the electrical energy 73, so that as being controlled by the processing unit 71, the electrical energy 73 is supplied to the resistance actuating windings 52 of the resistance applying device 5. Since the resistance actuating windings 52 are coupled, in an electromagnetic manner, to the high magnetic permeability ring 53 (or directly coupled to the flywheel 1 made of magnetic permeability material), so that the resistance applying device 5 may apply a resisting force to the flywheel 1. An energy storage device 75 is connected to the electrical energy 73, so that the electrical energy 73 may be charged toward the energy storage device 75.

The control circuit 7 may comprise a speed sensor 76, which is connected to the processing unit 71 to detect, at least, a speed signal of the power generation/drive device 6 or the flywheel 1 and transmit the signal to the processing unit 71. Further, the control circuit 7 may further comprise a feedback circuit 77, which is connected to the processing unit 71 and the resistance applying device 5 to detect, at least, a feedback signal of the resistance applying device 5 and transmit the signal to the processing unit 71.

Based on the arrangement of the present invention, when the flywheel 1 is acted upon by an external force and is rotated, the present invention is operated in a resistance power generation mode. The power generation/drive device 6 is caused by the rotation of the flywheel 1 to rotate, so that the power actuating windings 62, due to electromagnetic coupling thereof with the plurality of magnets 63, generate electrical energy. The electrical energy, as being controlled by the control circuit 7, is supplied to the resistance actuating windings 52 of the resistance applying device 5 to allow the resistance applying device 5 to apply a resisting force to the flywheel 1.

When an external electrical power (such as that supplied from the energy storage device 75 or an available external electrical power) is supplied to the power actuating windings 62 of the power generation/drive device 6, the present invention is operated in an electric motor mode. The power actuating windings 62, due to electromagnetic coupling thereof with the magnets 63, is capable of driving the flywheel 1 to rotate.

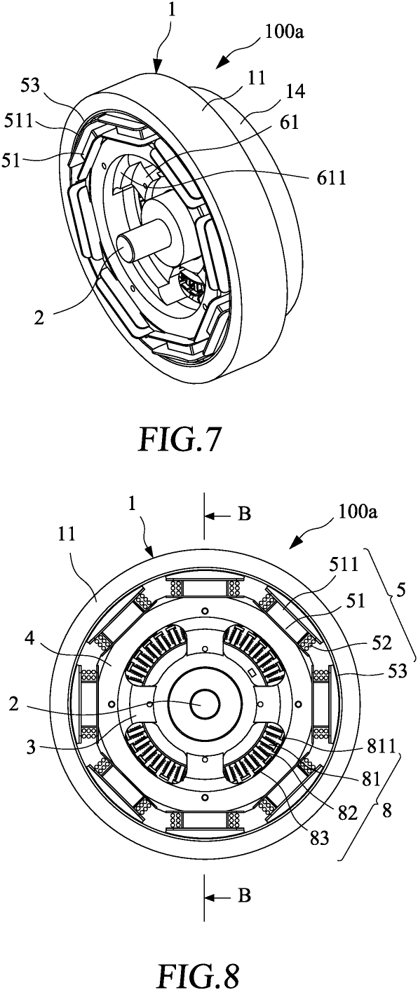

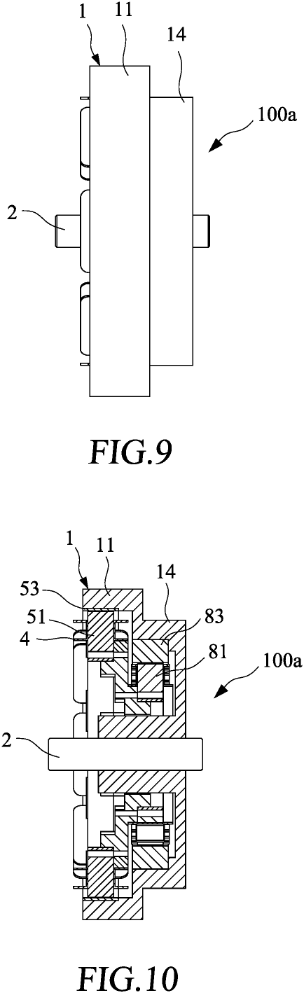

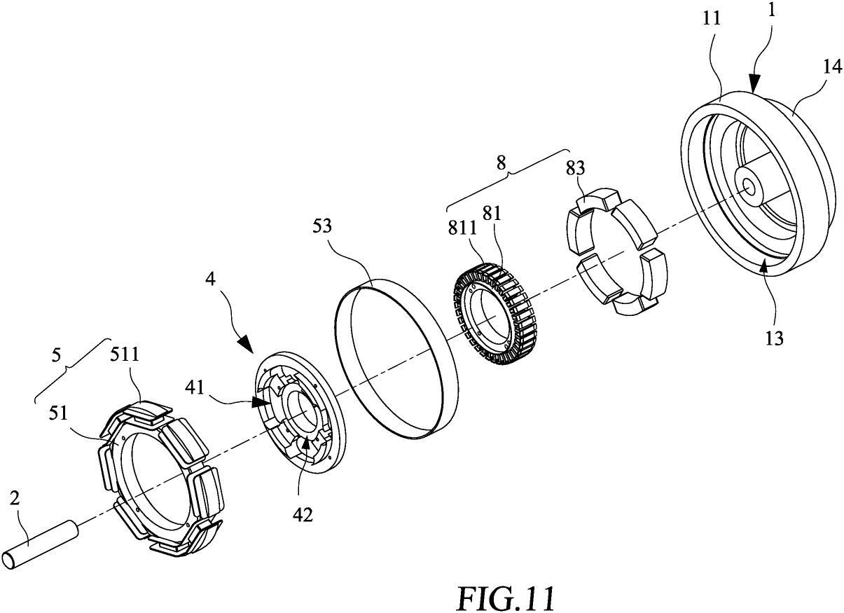

Referring to FIGS. 7-11, which show, respectively, a perspective view, a front view, a side elevational view, a cross-sectional view, and an exploded view of an integrated flywheel control apparatus 100a according to the present invention, the constitutional components of the instant embodiment are generally similar to those of the first embodiment, and identical components are designated with the same reference signs. In the instant embodiment, a protruded axle portion 14 is formed on a side surface of the sidewall 12 of the flywheel 1 and is coaxial with the flywheel 1, and the protruded axle portion 14 has an inner annular surface on which a plurality of magnets 83 that are spaced from each other are circumferentially arranged.

The instant embodiment similarly comprises a stator holder frame 4, a resistance applying device 5, and a high magnetic permeability ring 53. The resistance applying device 5 is similarly positioned on the outer frame 41 of the stator holder frame 4. However, the instant embodiment comprises a power generation/drive device 8, which is positioned on the inner frame 42 of the stator holder frame 4 and is located in an interior of the protruded axle portion 14 of the flywheel 1. Further, the power generation/drive device 8 comprises a second silicon lamination member 81 that has an outer annular surface from which a plurality of magnetic poles 811 are protruded outward and correspond to the magnets 83. The plurality of magnetic poles 811 are wound with power actuating windings 82 thereon. The control circuit shown in FIG. 6 is equally applicable to the instant embodiment.

In the instant embodiment, when the flywheel 1 is acted upon by an external force and is rotated, the present invention is operated in a resistance power generation mode. The power generation/drive device 8 is caused by the rotation of the flywheel 1 to rotate, so that the power actuating windings 82, due to electromagnetic coupling thereof with the magnets 8, generate electrical energy. The electrical energy, as being controlled by the control circuit 7, is supplied to the resistance actuating windings 52 of the resistance applying device 5 to allow the resistance applying device 5 to apply a resisting force to the flywheel 1.

When an external electrical power (such as that supplied from the energy storage device 75 or an available external electrical power) is supplied to the power actuating windings 82 of the power generation/drive device 8, the present invention is operated in an electric motor mode. The power actuating windings 82, due to electromagnetic coupling thereof with the magnets 83, is capable of driving the flywheel 1 to rotate.

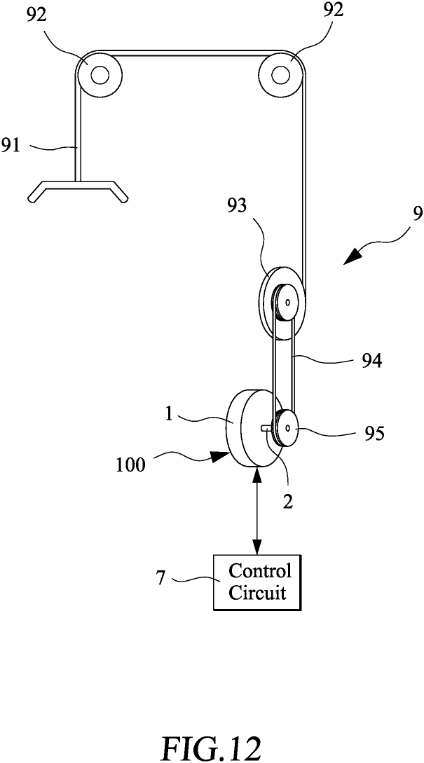

FIG. 12 is a schematic view showing an application of the present invention in simulating a strength training machine. As shown in the drawing, the strength training machine is incorporated, by means of a pulling assembly 9, with the integrated flywheel control apparatus 100 of the present invention (or, alternatively, the integrated flywheel control apparatus 100a of the present invention).

The pulling assembly 9 comprises a pull cord 91, at least one guide roller 92, an intermediate pulley 93, a belt 94, and a shaft pulley 95. The integrated flywheel control apparatus 100 of the present invention (or the integrated flywheel control apparatus 100a of the present invention) is arranged such that the central shaft 2 is connected, by means of the shaft pulley 95 and the belt 94, to the intermediate pulley 93. In the application, the integrated flywheel control apparatus 100 resembles, or takes the place of, a weight member of a known strength training machine.

Optionally, a known gearbox with a set of gears may be coupled to the central shaft 2 of the flywheel 1 incorporated with the integrated flywheel control apparatus 100 of the present invention to change the rotational speed of the flywheel 1, thereby increasing torque adaptation of the flywheel 1 when a user operates the pulling assembly 9.

When a user pulls downward the pull cord 91 of the pulling assembly 9, the pull cord 91 drives the intermediate pulley 93 through the guide roller to rotate, and then, the belt 94 drives the shaft pulley 95 and the flywheel 1 to rotate. Under the control of the control circuit 7, the integrated flywheel control apparatus 100 of the present invention is now operating in the resistance power generation mode. As such, the user would experience resistance when pulling the pull cord 91.

When the user stops pulling the pull cord 91, the integrated flywheel control apparatus 100 of the present invention is switched to an electric motor mode. As such, under the control of the control circuit 7, the user would experience, at this moment, a force that pulls upward is applied from the pull cord 91.

The embodiments described above are provided only for illustrating the present invention and are not intended to limit the scope of the present invention that is defined in the claims. Equivalent modifications or substitutes that come in the inventive spirit disclosed in the present invention are considered falling within the scope defined by the claims.

What is claimed is:

1. An integrated flywheel control apparatus for applying resisting force or driving force to a flywheel having a wheel body, a sidewall, a central shaft and an axle portion, comprising:
a plurality of magnets circumferentially arranged on an outer annular surface of the axle portion of the flywheel;
a stator holder frame arranged in a receiving space defined by the wheel body of the flywheel, the stator holder frame defining an outer frame and an inner frame;
a resistance applying device positioned on the outer frame of the stator holder frame, the resistance applying device including a first silicon lamination member which has an outer annular surface from which a plurality of magnetic poles are protruded outward and arranged circumferentially and receive a plurality of resistance actuating windings wound thereon; and
a power generation/drive device positioned on the inner frame of the stator holder frame and is arranged in a central hollow space defined by the first silicon lamination member, the power generation/drive device including a second silicon lamination member which has an inner annular surface from which a plurality of magnetic poles are protruded inward and arranged circumferentially, the plurality of magnetic poles corresponding to the plurality of magnets and receiving a plurality of power actuating windings wound thereon;
wherein when the flywheel is acted upon by an external force to rotate, the power generation/drive device is caused by the rotation of the flywheel to rotate and the plurality of power actuating windings generate and send an electrical energy to the plurality of resistance actuating windings under control of a control circuit to cause the resistance applying device to apply a resisting force to the flywheel; and
when the plurality of power actuating windings of the power generation/drive device is supplied with an external electrical power, the plurality of power actuating windings are electromagnetically coupled to the plurality of magnets to drive the flywheel to rotate.

2. The apparatus according to claim 1, a high magnetic permeability ring being further arranged on an inner annular wall of the wheel body of the flywheel to correspond to the plurality of magnetic poles of the first silicon lamination member.

3. The apparatus according to claim 1, wherein the control circuit comprises:
a processing unit;
a rectifier and filter circuit electrically connected to the plurality of power actuating windings of the power generation/drive device to rectify and filter the electrical energy generated by the plurality of power actuating windings to generate an electrical energy;
a driving circuit electrically connected to the processing unit and the electrical energy, so as to supply, as being controlled by the processing unit, the electrical energy to the resistance applying device to cause the resistance applying device to apply the resisting force to the flywheel; and
an energy storage device electrically connected to the electrical energy and chargeable with the electrical energy.

4. The apparatus according to claim 3, wherein the control circuit further comprises a speed sensor electrically connected to the processing unit to detect and transmit at least a speed signal of the flywheel to the processing unit.

5. The apparatus according to claim 3, wherein the control circuit further comprises a feedback circuit electrically connected to the processing unit and the resistance applying device to detect and transmit at least a feedback signal of the resistance applying device to the processing unit.

6. The apparatus according to claim 1, wherein a side surface of the second silicon lamination member is substantially coplanar with a side surface of the first silicon lamination member.

7. The apparatus according to claim 1, wherein the central shaft of the flywheel is combined with a pulling assembly, the pulling assembly being operated by a user to drive the central shaft and the flywheel to simultaneously rotate.

8. The device according to claim 7, wherein the pulling assembly comprises a pull cord, at least one guide roller, an intermediate pulley, a belt and an shaft pulley, wherein the central shaft is connected by means of the shaft pulley and the belt to the intermediate pulley, and the intermediate pulley is connected to the pull cord, the pull cord being adapted to be pulled by the user to drive the central shaft and the flywheel to rotate through the at least one guide roller, the intermediate pulley, the belt and the shaft pulley.

9. An integrated flywheel control apparatus for applying resisting force or driving force to a flywheel having a wheel body, a sidewall, a central shaft, an axle portion and a protruded axle portion, the protruded axle portion being formed on a side surface of the sidewall and having an inner annular surface, comprising:
a plurality of magnets circumferentially arranged on the inner annular surface of the protruded axle portion of the flywheel;
a stator holder frame arranged in a receiving space defined by the wheel body of the flywheel, the stator holder frame defining an outer frame and an inner frame;
a resistance applying device positioned on the outer frame of the stator holder frame, the resistance applying device including a first silicon lamination member which has an outer annular surface from which a plurality of magnetic poles are protruded outward and arranged circumferentially and receive a plurality of resistance actuating windings wound thereon; and
a power generation/drive device positioned on the inner frame of the stator holder frame, the power generation/drive device including a second silicon lamination member which has an outer annular surface from which a plurality of magnetic poles are protruded outward and arranged circumferentially, the plurality of magnetic poles corresponding to the plurality of magnets and receiving a plurality of power actuating windings wound thereon;
wherein when the flywheel is acted upon by an external force to rotate, the power generation/drive device is caused by the rotation of the flywheel to rotate and the plurality of power actuating windings generate and send an electrical energy to the plurality of resistance actuating windings under control of a control circuit to cause the resistance applying device to apply a resisting force to the flywheel; and
when the plurality of power actuating windings of the power generation/drive device is supplied with an external electrical power, the plurality of power actuating windings are electromagnetically coupled to the plurality of magnets to drive the flywheel to rotate.

10. The apparatus according to claim 9, a high magnetic permeability ring being further arranged on an inner annular wall of the wheel body of the flywheel to correspond to the plurality of magnetic poles of the first silicon lamination member.

11. The apparatus according to claim 9, wherein the control circuit comprises:
a processing unit;
a rectifier and filter circuit electrically connected to the plurality of power actuating windings of the power generation/drive device to rectify and filter the electrical energy generated by the plurality of power actuating windings to generate an electrical energy;
a driving circuit electrically connected to the processing unit and the electrical energy, so as to supply, as being controlled by the processing unit, the electrical energy to the resistance applying device to cause the resistance applying device to apply the resisting force to the flywheel; and
an energy storage device electrically connected to the electrical energy and chargeable with the electrical energy.

12. The apparatus according to claim 11, wherein the control circuit further comprises a speed sensor electrically connected to the processing unit to detect and transmit at least a speed signal of the flywheel to the processing unit.

13. The apparatus according to claim 11, wherein the control circuit further comprises a feedback circuit electrically connected to the processing unit and the resistance applying device to detect and transmit at least a feedback signal of the resistance applying device to the processing unit.

14. The apparatus according to claim 9, wherein the central shaft of the flywheel is combined with a pulling assembly, the pulling assembly being operated by a user to drive the central shaft and the flywheel to simultaneously rotate.

15. The device according to claim 14, wherein the pulling assembly comprises a pull cord, at least one guide roller, an intermediate pulley, a belt and an shaft pulley, wherein the central shaft is connected by means of the shaft pulley and the belt to the intermediate pulley, and the intermediate pulley is connected to the pull cord, the pull cord being adapted to be pulled by the user to drive the central shaft and the flywheel to rotate through the at least one guide roller, the intermediate pulley, the belt and the shaft pulley.
